(19) United States
(12) Patent Application Publication
(10) Pub. No.: US 2008/0264773 A1
(43) Pub. Date: Oct. 30, 2008

(54) In vitro prophylactic on site ion-exchange purification process.

(76) Inventor: Warren W. Searles, Rockton, IL (US)

Correspondence Address: HydroTec Systems Company, Inc., 145 East Main Street, Tiskilwa, IL, 61368, US

(21) Appl. No.: 11/741,503

(22) Filed: Apr. 27, 2007

(51) Int. Cl. C02F 1/467

(52) U.S. Cl. 204/158.2; 204/632

(57) ABSTRACT

This invention describes a method and apparatus for the In Vitro treatment process of purifying and maintaining the sterility of water thereby replacing existing transient technology that is flawed by repeated handling inside and outside the medical environment where this technology is intended for use i. e. hemodialysis clinics, trauma centers, burn centers, general medical institutions the pharmaceutical packager and other locations and applications where purified sterile water is required.

### REFERENCES CITED, PREVIOUS PATENTS RELATED TO THE FIELD OF STUDY

| | | |
|---|---|---|
| 2546254 | March 1951 | Briggs |
| 2694680 | November 1954 | Katz et al. |
| 2763607 | September 1956 | Staverman |
| 2812300 | November 1957 | Pearson |
| 2923674 | February 1960 | Kressman et al |
| 2980598 | April 1961 | Stoddard |
| 3006828 | October 1961 | Gaysowski |
| 3074864 | January 1963 | Gaysowski |
| 3239442 | March 1966 | Tirrell |
| 3637482 | January 1972 | Vajda |
| 3682806 | August 1972 | Kinsella, et al. |
| 3719570 | March 1973 | Lancy; Leslie E. |
| 3869376 | March 1975 | Tejeda |
| 3975246 | August 1976 | Eibl, et al. |
| 4032452 | June 1977 | Davis |
| 4387026 | June 1983 | Woolacott; Charles F. |
| 4632745 | December 1986 | Giuffrida, et al. |
| 4465573 | Aug. 14, 1984 | O'Hare |
| 4610790 | September 1986 | Reti, et al. |
| 4906372 | March 1990 | Hopkins, David |
| 4925541 | May 1990 | Giuffrida, et al. |
| 5154809 | October 1992 | Oren, et al. |
| 5284833 | February 1994 | McAnalley, et al. |
| 5211823 | May 1993 | Giuffrida, et al. |
| 5538642 | July 1996 | Solie, Gregory |
| 5858191 | January 1999 | DiMascio, et al. |
| 5868915 | February 1999 | Ganzi, et al. |
| 6241866 | June 2001 | Mir, Leon, et al. |
| 6241867 | June 2001 | Mir, Leon |
| 6365023 | April 2002 | De Los Reyes, et al. |
| 6398965 | June 2002 | Arba, et al. |
| 6495014 | December 2002 | Datta, et al. |
| 6503957 | January 2003 | Bernatowicz, et al. |
| 6649037 | November 2003 | Liang, et al. |
| 6824662 | November 2004 | Liang, et al. |
| 6919320 | July 2005 | von Borstel, et al. |
| 6929748 | August 2005 | Avijit, et al. |
| 7156997 | January 2007 | Marsh, et al. |

### OTHER REFERENCES, LITERATURE EXAMINATION

Davis, Dulbecco, Eisen, Ginsburg, et al. Chapter 4 page 68, Medical Microbology, 4^{th} Edition, J. B. Lippincott Co. (1990)
Boyd, Hoerl, et al., pages 217 & 218, Basic Medical Microbiology, 3^{rd} Edition, Little Brown & Co. (1981).
Cano, Colomo, et al. Chapter 4, Nutrition and Growth of Microorganisms, Essentials of Microbiology, West Publishing Co. (1988).
Joklik, Willett, Amos, Wilfort, et al., page 56, Hydrogen Ion Concentration, Zinsser Microbiology, 20^{th} Edition, Appleton & Hang div. Prentice Hall (1988).
Harry L. T. Mobley et al.: “Helicobacter pylori: Physiology and Genetics”; Chapter 21. Motility, paragraph concerning Chemotaxis, and Flagella. ASM Press ISBN 978-1-55581-213-3 (2001) Cited by others.
Peter Faletra Ph.D. Written response to question concerning pH and bacteria proffered by an inquiry to the DOE “Ask a scientist”; Argonne National Laboratory, Division of Educational Programs, Harold Myron, Ph.D., Division Director, (2004).
Kenneth Todar Ph.D. The Effect of pH on Growth, Text, book of Bacteriology, University of Wisconsin—Madison Department of Bacteriology (2006).
James Taylor, Ed Jacobs; Chapter 9 Reverse osmosis and Nanofiltration: Water Treatment Membrane Processes/American Water Works Association, Research Foundation, Lyonnaise des Eaux, Water Research Commission of South Africa; McGraw-Hill 1996.
Japie Schoeman, Mark Thompson; Chapter 12 Electrodialysis; Water Treatment Membrane Processes/American Water Works Association, Research Foundation, Lyonnaise des Eaux, Water Research Commission of South Africa; McGraw-Hill 1996.
O'Hare, et al. OEM Engineering Manual XL Series EDI, SNOWPURE LLC, 2006 VERSION 2.6.5(XL)—NOVEMBER 2006
O'Hare, et al. Zapwater® Laboratory EDI OEM Engineering Manual, ELECTROPURE EDI, INC. VERSION 1.05 (ZAP) (Electropure was purchased by SnowPure in 2005) Revised October 2004.
Stephen Lower, Chem. 1 virtual textbook, a reference text for General Chemistry, Simon Fraser University—Burnaby/Vancouver Canada; Last modified May 3, 2007
James A. Plambeck. Table of Electro Chemical properties of ionic solids, University of Alberto, Canada On-line Studies, Updated Jun. 15, 1996 jp.

### BACKGROUND OF THE INVENTION

1. Field of the Invention

This invention describes a method and apparatus for the In Vitro treatment method of purifying and maintaining the sterility of water thereby replacing existing transient technology that is flawed by repeated handling inside and outside the medical environment where this technology is intended for use i. e. hemodialysis clinics, trauma centers and general medical institutions where purified sterile water is required.

2. Background of the Invention

Charles F. Woolacott through his invention provided for an improvement to the service ion-exchange regeneration as demonstrated in his patent (U.S. Pat. No. 4,387,026). He stated: the present invention provides an improved exhausted ion-exchange material regeneration process and apparatus therefore. The process is automated to minimize labor requirements and to ensure close control of operations.

The invention includes a plurality of interconnected operations and equipment. The elements of equipment include: (a) A water supply treatment unit to process municipal water supply into forms utilizable in the plant; (b) A cylinder emptying facility in which service cylinders containing exhausted resin are discharged; (c) A pretreatment and separation unit in which the exhausted resin is pretreated to ensure complete exhaustion of the resin, to destroy microorganisms and to remove calcium fouling chemicals and certain organic foulants, and thereafter is separated into anionic and cationic resin fractions. The separation is not required if the resin bed removed from the cylinder is of a single type; (d) A resin regeneration unit in which anionic and cationic resin is separately and simultaneously regenerated; (e) A cylinder recharging facility in which the regenerated resin is mixed and charged to cylinders, in the case of a mixed bed requirement, or in which the individual regenerated resins are separately charged to cylinders in the case of a single bed requirements.

The Federal Drug and Food Administration listed under product code FIP, Regulation Number 876.5665 treatment systems for providing water purification system For hemodialysis; Class II; Water purification system for hemodialysis. The regeneration equipment Mr. Woolacott describes is used to regenerate the service or removable ion-exchange columns that are used to further purify the reverse osmosis water and supply that water to the hemodialysis unit to be used as the waste flushing stream from the artificial kidney and as reagent grade water for dialysate makeup. Patent (U.S. Pat. No. 4,387,026) provides for automation of the regeneration process, but does not relieve the service technician of having to manually handle the columns that are used to treat the chronic disease of kidney failure.

This method and apparatus replaces the exchange deionization columns with an in vitro device that continually regenerates on site and thereby provides biologically safe water the device has been demonstrated as being biostatic that is prophylactic to the passage of bacteria and other biological entities that might pass from the reverse osmosis unit or become contaminated through handling the offsite regenerated service ion-exchange columns.

3. Description of Prior Art

Kressman et al, patent (U.S. Pat. No. 2,923,674) claims: it will be appreciated that while possible to effect demineralization by passing an aqueous solution first through a desalting compartment filled with an anion exchange material and then through one filled with a cation-exchange material, this may lead to the formation of large quantities of precipitate and scale in the first desalting compartment owing to the accumulation of hydroxyl (OH⁻) ions in the presents of metals, e.g. calcium and magnesium, which form insoluble hydroxides, and carbonates. By means of the invention this is avoided, as the solution entering the compartments filled with anion-exchange material is already sufficiently acid to neutralize the hydroxyl ions immediately they are formed and converted into water.

Kressman, et al, have disclosed that there moving pH fields within the Continuous Electronic Ion-exchange where with the hydrogen proton concentration shifting from positive concentration to negative concentrations with in the ion-exchange resin or from low to high pHs. Their invention has been improved by Mr. O'Hare (U.S. Pat. No. 4,465,573) by replacing mixed (forty percent cation and 60 percent anion) resin in each cell instead of providing alternating cation and anion cells. However, their work exposed the pH shifts in each cell and is a basis to our determining the biostatic nature of the CEIX (electro-deionization apparatus) process we describe.

Furthermore Eibl; Volker (Munich, DT), Reis; August (Munich, DT) make further clams of disinfection in their patent (U.S. Pat. No. 3,975,246) claiming that: A method of disinfecting water which comprises: a. supplying the water to he disinfected to the anode compartment of an electrolytic cell, the cell being divided into said anode compartment and a cathode compartment by a membrane permeable to anions and having an anode and a cathode in said compartments respectively; b. maintaining in said cathode compartment an aqueous solution of a member of the group consisting of the chloride, hydroxide, carbonate, and peroxide of an alkali metal, hydrogen chloride, and hydrogen peroxide; c. passing direct current between said anode and said cathode through said cell; and d. withdrawing disinfected water from said anode compartment,

Volker Reis and August disinfection process is accelerate by the described process, however, the same ionic compounds exist in reverse osmosis permeate so imply disinfection of an CEIX (electro-deionization apparatus) as an ordinary state of the process where gasses that are potential oxidants are created within the cell creating as a minimum a biostatic environment as we describe.

Lancy; Leslie E. claimed in his patent (U.S. Pat. No. 3,719,570): A process for producing an oxidant from a solution containing an electrolytically decomposable oxidation causing precursor compound for use with a waste solution such as pollutants, noxious or toxic substances comprising the steps of: adding an electrolytically decomposable oxidation causing precursor compound to a solution and containing said solution in a vessel having at least a pair of electrodes including a cathode and an anode therein; a bed including a multiplicity of particulate packing elements, contained in said vessel, said elements providing a circuitous path for gases generated electrolytically in said vessel whereby the vessel retention time of the generated gases is increased; causing an electrical current to flow between said anode and said cathode causing an oxidant to be produced in said solution; isolating the cathode electrode by a porous cup to prevent adding to the treatment solution reducing components not desired for the reaction; and using the preferred oxidant to oxidize a pollutant, noxious or toxic substance in solution in an oxidation zone.

Lancy claim, taken to an extreme, i.e. permitting an excess of salt passage from the reverse osmosis process, will create oxidants in the individual cells, hence the need to vent gasses away from the process. Membranes used in both the reverse osmosis and continuous electronic ion-exchange process readily permit gases to pass through them, therefore, the need to vent. However, the instability of isolated pockets of dissolved gases promotes the sanitation within each cell supporting our claims.

Reti; Adrian R., Benn; James A. in Patent (U.S. Pat. No. 4,610,790) claimed: A process for producing water substantially free of pyrogens to produce USP XX grade water for injection or irrigation solutions which comprises passing drinking quality water through a water purification system comprising: (a) a filtration step to remove organic impurities; (b) a reverse osmosis separation step to remove dissolved solids or ions, pyrogens and microorganisms from said water; (c) a deionization step to remove ions from said water and to increase the electrical resistance of said water; (d) an ultrafiltration step downstream of steps (a), (b) and (c) thereby to remove pyrogens from said water; and (e) periodically washing ion exchange means in the deionization step for removing ions from said water and a membrane utilized in the Ultrafiltration step with water heated to a temperature to sterilize microorganisms in said deionization and ultrafiltration steps and to remove impurities accumulated, in said deionization step and said ultrafiltration step while avoiding washing steps (a) and (b) with said heated water.

Reti and Benn introduced an ultrafiltration step to ensure that biological material, even fractured biological material is removed by the reverse osmosis and Ion-exchange process, the addition of the prophylactic ultrafiltration device may still be required to remove pyrogens notably the bacterial capsules that can not be exchanged as the polysaccharides likely will be by the CEIX devices. However, their devices underpin the overall composition of our system as depicted in FIGS. 1 and 2.

Ganzi, et al. in their abstract (U.S. Pat. No. 5,868,915) describing a particular modification to the EDI process for processing aqueous solution for purposes other than water treatment state: An improved electrodeionization apparatus and method are provided. The electrodeionization apparatus includes electrolyte compartments, ion-concentrating, and ion-depleting compartments, having electroactive media therein. The electroactive media can be induced to have a reversible change in its chemical or electrical properties upon imposition of an external electrical field or the presence of an electrically charged substance. The change in chemical or electrical properties of the media results in a desired change in the transport or chemical properties of the media. The incorporation of the improved electroactive media also provides for an improved, and more reliable electrodeionization process in applications requiring chemical and temperature resistance media, where localized pH shifts would be harmful to the product being deionized, under temperature and chemical conditions of the liquid to be processed, or under circumstances where traditional media would tend to foul.

Ganzi, et al. have provided a device that is resultant to pH changes within the cell demonstrates the fluid changes within the individual cells create unstable pH fronts that have been shown to limit the growth or even kill bacteria as we have claimed.

De Los Reyes, et al. (U.S. Pat. No. 6,365,023) explains in a summary or their invention that at the electrodes any accumulated scale is cleaned during the anodic cycle and any accumulated organics are dissolved during the catholic cycle and are removed. Also, any accumulated scale in the concentrating compartments is dissolved during the initial period of the diluting cycle and is rinsed to drain. In addition, any organic foul ants accumulated during the diluting cycle are desorbed from the resin and membranes during the concentrating cycle by the action of increased salinity and pH and removed in the waste stream so that their presence does not adversely affect the quality of the water or function of the equipment.

De Los Reyes, et al. demonstrate the functionality of the EDI process as self contained a device capable of simple cleansing without the external application of chemicals or the removal and handling to regenerate, clean or effectively sanitize.

Arba, et al. In their invention's specification (U.S. Pat. No. 6,398,965) establish the use of membrane separation technology, particularly Reverse Osmosis as pretreatment: The water is then passed to a cartridge filtration unit which provides a final filtration to protect the reverse osmosis membranes from fouling or other damage caused by relatively large particles generated from upstream equipment. The water is then passed to a reverse osmosis unit, which typically removes greater than 98 percent of dissolved substances from the feed water. Although not shown, a double-pass configuration of reverse osmosis units can be used to achieve high quality purified water. The permeate from the reverse osmosis unit(s) is then passed to a distillation unit for the production of water for injection.

Arba, et al. establish the use and indeed the need for reverse osmosis as a pretreatment for CEDI or Electrodialysis as a definitive part of the total process.

Datta, et al. in their modification (U.S. Pat. No. 6,495,014) to previous EDI devices describe the process in their claim as: An electrodeionization device comprising: a) a cation-exchange membrane; b) an anion-exchange membrane juxtaposed co-planarly to said cation exchange membrane; c) porous ion-exchange material, in the form of a wafer capable of being squeezed and stretched, positioned intermediate said cation-exchange membrane and said anion exchange membrane to form a compartment, wherein the material comprises anion-exchange entities and cation exchange entities immobilized relative to each other via a binder which comprises 25 to 35 weight percent of said material but which does not substantially coat the entities; and d) a means for applying an electrical potential to said compartment.

Datta, et al. describe the primary design of a EDI cell and depict the continuous action of the interface between the resin and the electrical potential and the purification of the aqueous solution passing through that cell and make obvious the formation of electrical potential within their process. Their improvement is being cited because it clearly demonstrates the CEIX process.

von Borstel, et al. in claim 4, shown below, of their Patent (U.S. Pat. No. 6,919,320) indicates the requirement of a ‘pharmaceutically acceptable carrier’ review on their examples and in listed previous inventions defines this carrier as purified or sterile water: composition of matter in the form of a lotion, ointment, cream or gel, comprising, an active agent comprising (a) from 10 to 90 percent by mol 2′-deoxycytidine, and (b) from 90 to 10 percent by mol 2′-deoxyguanosine, each of said 2′-deoxycytidine and 2′-deoxyguanosine being present as (i) the free from thereof, or (ii) a substituted derivative of (a) or (b), wherein one or both of said 2′-deoxycytidine and 2′-deoxyguanosine are substituted by one or more groups which may be the same or different, at one or both hydroxyl groups in the deoxyribose moiety and/or substituted in the exocyclic amine on the purine ring of 2′-deoxyguanosine or in the exocyclic amine on the pyrimidine ring of 2′-deoxycytidine by an acyl radicals containing 2 to 20 carbon atoms, or the pharmaceutically acceptable salts thereof and a pharmaceutically acceptable carrier; wherein said active agent is present at a concentration such that said composition is capable of promoting wound healing in an animal, and wherein said carrier is adapted for local or topical administration.

von Borstel, et al establish the use of purified, that is, sterile water is key to the success of their experiments in that water not purified and not sterile will promote rejection of their invention and decelerate healing of wounds, abrasions, cuts, incisions, and superficial burns induced by heat, sunlight, chemical agents, and or infections.

Avijit, et al. describe, as they discuss the background of their innovation (U.S. Pat. No. 6,929,748), that several inventors have stated in their discoveries that they have designed into their apparatus methods to limit the random mixture of the cation and anion resin in each cell. The describe successful attempt to provide a homogeneous mixture of resins to eliminate localized regions of the electrodeionization apparatus where high or low pH thereby eliminate scaling, furthermore current levels promote boundary layers within the apparatus and that the regulation of current would prevent scaling or overcome scaling by elevated pH indicating an increase in Hydroxyl ions thus increasing the possibility of creating slightly soluble metal hydroxides at the boundary layer

These disclosures describe the flow of pH boundaries through out the electrodeionization apparatus corroborating that these pH fields exist around the cation and anion resin beads and in reported boundary layers within the continually regenerating resin bed.

Electrical current is also discussed by Avijit, et al. as they discuss the background of their innovation (U.S. Pat. No. 6,929,748). This electrical current is passing through the aqueous regions of the apparatus creating an electrical potential thereby providing for the movement of ionic solids toward either the cathode or anode depending on the charge of the species of ion. They quote: In electrodeionization apparatus, H (positive) ions and OH (negative) ions are formed by dissociation of the water to continuously regenerate the ion exchanging resins filled in the purifying compartments so that the electrodeionization apparatus can efficiently deionize water. The high electric voltage in the dilute compartment not only splits water, but also destroys some of the low molecular weight organics that pass through the preceding reverse osmosis system (Auerswald, D., “Optimizing the Performance of a Reverse Osmosis/Continuous Electrodeionization System”, Ultrapure Water, pp 35-52, May/June 1996).

Avijit's description of the operation of an electrodeionization apparatus provides further conformation that the electrical potential of the cell creates an unstable field hostile to bacteria discouraging mitosis; therefore, disrupting colony forming. As shown in the external literature instability of any particular typology within the apparatus prevents biological growth.

Prior Art beyond the above described was considered and in cases was considered valid but repetitious. Several inventions described the electrodeionization apparatus in construction and added details concerning the electrochemical nature of the primary device and have considered in the use we recognize, these are: U.S. Pat. Nos. 2,546,254, 2,694,680, 2,763,607, 2,812,300, 2,980,598, 3,006,828, 3,074,864, 3,239,442, 5,858,191, 6,503,957, 4,032,452, 4,632,745, and 4,925,541, 514,809 and 5,154,809

Prior Art was instrumental in assisting the development of FIGS. 4 and 5 that art is: U.S. Pat. Nos. 3,682,806, 3,869,376, 5,211,823, 6,241,866, 6,241,867, 6,649,037, and 6,824,662.

Prior Art was instrumental is the discussion of reverse osmosis improvements as a pretreatment to the electrodeionization apparatus, art referenced is U.S. Pat. No. 4,906,372, 5,538,642, and 7,156,997.

A use of our invention is referenced Marsh; et al. (U.S. Pat. No. 5,284,833) invention of a wound cleansing compound indicates that DI water is used in the making of this compound that this water is to be sterile. Though this invention is a possible application of out discovery, it is important to note a use of this invention in a clinical application where this device is intended for use.

Exterior Contributing Information Perpetuation the Invention's Claims:

Established research demonstrates a relationship to changes in pH and the inability for bacteria to grow in the shifting fields. Basic Medical Microbiology, 3^{rd} Edition indicates that bacteria can exist in aqueous solutions with a pH above 4.5, but below that a food product may be considered sterile without Pasteurization with pressure and heat. It is established by the various cell manufacturers that there are waves of pH pulsing through the cell where the presents of free mineral acidify temporally take place, with pH ranges below 4.5.

Furthermore Zinner Microbiology, 20^{th} Edition indicates that a minor change of 0.1 units can greatly disrupt the metabolism of the cell's nuclear cytoplasm's pH disrupting cell growth or worse.

Literature, which is, Faletra, Todar et al., review support claims concerning the relationship of pH to microbiological growth, where as a stable pH centered on the particular organism's particular requirements enhance the growth and mitosis of a single sell system. While on the other hand a unstable pH within an isolated milieu does indeed have the opposite affect on cell growth it is retarded or eliminated all together.

EDI modules under applied voltage are constantly splitting water and generate locally very high and very low pH. These pH extremes are believed to create a biostatic environment within the EDI module, especially on the product side where it is critical.

A study of this topic was published by Millipore in 1990. They found that when a weekly-sanitized procedure was performed on the RO-EDI system, the system maintained low bacterial and endotoxin counts, and that the EDI effluent was similar in counts to its influent. However, when the sanitization regimen was stopped for three months, the concentrate stream did rise in counts, yet the product stream did not. Their conclusion was that the critical product side of the EDI module did indeed act as a biostat.

Chapter 12 Electrodialysis; Water Treatment Membrane Processes/American Water Works Association discusses polarization in electrodialysis is widely described in the literature (Korngold, 1984; Davis and Brockman, 1972; Hodgkiness 1987; Meller, 1984; Rubenstein, 1984). Current density in ED/EDR can be increased until the current to transfer the ions exceeds the number of ions available to be transferred (Meller, 1984). This point is called the limiting current density. Limiting current density is usury expressed as (CD/Nd)lim, where CD is current density (the amount of current carried by a unity area of membrane surface) and Nd is the normality of the demineralized water outlet stream. This limit is a function of the fluid velocity in the flow path, steam temperature, and types of ions present. While practically all ions are transported through the membranes in ED/EDR by electric transport, only half of the ions arrive at the membrane surface form the bulk of solution are earned by electrical transport. The remaining ions arrive at the membrane surfaces from the flowing stream as a result of diffusion and convection process, AS ions are electrically transferred form the demineralizing cell through the membranes, the concentration of ions in the demineralizing cell in the thin layer immediately adjacent to the membrane surface become depleted. AS the current density is increased, the resistance rises sharply. The increased resistance results in increased voltage, which eventually exceeds the breakdown voltage for water molecules causing them to dissociate, forming (H+) and (OH−) ions. When such dissociation of the water molecules occurs, the polarization point is reached. Transfer of the hydrogen ions on the case of cation-exchange membranes and hydroxyl ions in the case of anion-exchange membranes becomes appreciable. The extent of transfer of hydrogen ions and hydroxyl ions depends on the ration of the concentration of hydrogen ions to other cations at the surface of cation-permeable membrane and the ratio of hydroxyl ions to other anions at the surface of anion-permeable membranes. Polarization thus occurs gradually as the voltage applied to the membrane cell (and, hence, the current density) is increased.

Chapter 12 (above) goes on to state; polarization, as discussed here, occurs only in the demineralizing compartments, since it is in these cells that the depletion is taking place. Polarization does not usually become significant at both membrane surfaces at the same time. When polarization becomes pronounced at the anion transfer membrane, hydroxyl ions are transferred into the concentrate stream, making it alkaline; the hydrogen ions remaining in the demineralizing cell from the dissociated water cause a decrease in the pH of the demineralized stream. Polarization at the cation transfer membrane results in the transfer of hydrogen ions into the concentrate stream, decreasing its pH and increasing the pH of the demineralized stream. Therefore, pH changes of the process streams can indicate polarization.

The best sanitization method, according to SnowPure, is to keep the unit operational. In this mode, bacterial colonies should not grow, especially on the product side.

Currently Accepted Technology

FIG. 2 details the existing FDA classified process listed under product code FIP, Regulation Number 876.5665. Water entering the system is typically a blend of hot water and cold water V1, the reasoning is two fold: a) the pump selected as the Reverse Osmosis booster pump P3 is more efficient when a consistent temperature supplied, b) by reducing the influence of temperature change the pump can be correctly selected to compensate for membrane and resin aging. Typically resin beads breaks into fragments termed by the industry “fines”; however, before the resin shatters it holds water in its structure, replacing the damaged cross linking material, the phenomena creates swelling and therefore added pressure drop.

The tempered supply water is consists of gross sediment (10) filtration, followed by a heavy metal removal by ion-exchange column (11), which is followed by a Granulated Activated Carbon column (13) selected to Total Chlorine from the supply water. An other advantage of placing the ORC column after to ion-exchange column 11 is that carbon filtering the ion-exchanged water will remove trace organics coming from the again resin media of that column. Water filtered by the GAC column (12) is then directed through a five micron, nominal, sediment filter (13) to remove carbon fines and other particulate mater prior to membrane separation. Other technologies such as Ultraviolet sanitation as well as other oxidation technologies can be applied if the supply water analysis indicates or the end user specifies further treatment based on their experience.

Well understood by the industry is that different supply water may require other treatment technologies as pretreatment for the systems discussed here. These technologies include: a) multimedia filtration, b) bacteria removal by; chlorination followed by dechlorination, c) using a standard 254 nanometer ultraviolet sanitizing unit to neuter bacteria so they cannot experience mitosis and therefore, colonize, d) Ultraviolet destruction organic using 185 nanometer ozone producing bulbs sized to either neuter the bacteria or break down the cell into carbon dioxide, water, and other particulates, or sterilize them so they cannot grow, e; micron and sub micron filtration for the removal of fractured bacteria and other sub-micron cartridge filtration, and f) Ozonation, halogens, silver and other biocidal treatments recognized by the industry as methods of destroying bacteria and viral contaminates, and various other recognized and effectual methods.

Effluent from pretreatment system is boosted in pressure by pump P3 to the pressure required to overcome osmotic pressure, membrane ageing and supply enough pressure to generate flow through the membrane to the permeate storage tank 50. The storage tank is equipped with a hydrophobic filter 51 that allows air to be drawn in when the water is pumped out and a discharge check opens permitting air to escape when the tank fills, the venting system prevents dust bearing bacteria, spores and other biological matter from entering the tank. Membrane separation 30 is typically reverse osmosis, however, depending on the supply water quality, Microfiltration, or Ultrafiltration followed by reverse osmosis membrane separation technology may be applied to provide adequate permeate quality for the polishing treatment equipment.

The Food and Drug Administration (FDA) product code FIP, Regulation Number 876.5665 recognizes rental or potable exchange deionization, as abbreviated DI as preexisting technology. Exchange DI may consist of a cation column followed by an anion column followed by a mixed resin column or Mixed Bed (MB) of typically forty percent cation and sixty percent anion resin selected for the purpose of being separated, separately regenerated and then remixed. In all known cases this process is performed away the Hospital's, clinics' or other approved medical locations where dialysis and wound irrigation is performed. Therefore, final elements of the current process described on FIG. 2 are a pump P2 to pressurize the water allowing it to pass through the Exchange DI consisting of the primary mixed resin bed 74 and the polishing mixed resin bed 75. Typically the freshly regenerated MB is placed, by the service technician in the polishing 75 mode and the MB that was in the polishing mode is placed in the primary 74 position and remains until it is exhausted. Following the resin beds is a cartridge filter typically a 0.1 micron rated as absolute cartridge filter 73. This cartridge may be housed in a specifically designed housing allow in double o-ring sealing of the cartridge into the housing. The FDA allows under product code FIP, Regulation Number 876.5665 a 0.22 cartridge in this location, however, the final cartridge is to be certifiable rated. Valve V2 diverts the water to the RO storage tank when water is not required.

The service of the DI columns requires manual handling by maintenance and, or service personnel The DI columns are initially handled at the service site where; as new tanks are manually filled with regenerated mixed ion-exchange resin in the ratio indicated in paragraph

then the service ports are covered with a plug suitable for the design of that connection, they are taken to the customers site to be placed in service when needed. Once the DI Columns are in service and then exhausted the DI columns are taking back to the off site location where either the DI column closures are manually removed to expose the resin or a plug is manually removed to permit extraction of the resin from the resin columns. The resin is then extracted for regeneration in a semi-automatic method. Each DI service site has its own procedure for regeneration, these procedures can significantly vary from regenerating the resin in ‘funnels’ where the anion component is backwashed into the funnel and regenerated there while the cation resin is regenerated in the resin tank in which it is transported for use in. In cases where the service provider has a batch regeneration system the resin is extracted from each DI column and sent to a separation tank, it is then separated in that tank into the cation and anion components. The separated resin is then sluiced; the cation resin is sent to an acid regeneration column and the anion resin sent to a base (caustic) regeneration column; once regenerated the resin is sent to a forth tank where it is mixed by blowing air through the resin to churn it back into a homogeneous compound. Service sites that use funnels mix the separated resin regeneration funnel, by allowing the anion resin to fall back into the transportation tank and then air is blown into that mixing tank allowing the over flow of resin caused by the churning to flow back into the funnel until the mix is completed. In either case the freshly regenerated resin is transferred back into the DI columns that are again re-sealed to be transported back to the use site. At the use site, the DI columns are placed in storage for use when the online DI columns are determined to he exhausted. When that determination is made the maintenance technician or service technician manually removes the exhausted column, manually removes the caps or protective closures on the DI columns connections then manually connects the DI service connections to the system readying them for use in the hemodialysis water treatment process. Each service site has numerous procedures in place in an attempt to maintain the sanitation of the resins, the columns, the closures and the service connections, still human contact is made with the equipment as have numerous environmental factors influence the sterility of the overall procedure.

### SUMMARY OF INVENTION

primary treatment device is a previously disclosed technology that derived by combining two commercially recognized techniques for processing potable water to USP XX and Reagent Grade ASME Type 1 and biologically safe water suitable to be considered Water For Injection (WFI). The device consists of a primary membrane separation reverse osmosis, known and an RO module followed by a Continuous Electronically regenerated ion exchange (DI), known as a CEIX module. Our invention is designed replaces the of-site regenerated, columns as described in paragraph [0048 and 0049] and to rearranges the order of the treatment scheme. This invention provides significant improvements over the existing technology, they are; 1) The CEIX (electrodeionization apparatus) allows equality water quality to that of the ionic purity of a polishing mixed resin bed described above, 2) Once installed the CEIX does not have to be removed for regeneration as are the service DI columns described; 3) the characteristics of the apparatus provides at a minimum a biostatic environment where bacteria do not colonize, 4) this same environment discourages cell mitosis and the development of toxins associated with cell growth, 5) the use of transmembrane membrane to drive the aqueous solution trough the CEIX apparatus and the final submicron filter, and 6) placing the storage vessel before the membrane treatment reducing the chance for dust to enter into the systems' permeate.

Pretreatment for this invention follows the same guidelines as does the pretreatment scheme for the current technology discussed above.

Our invention consists of treated supply water stored in a suitable storage system for USP water applications including a vent filtration unit desired to prevent dust form entering the storage tank. The storage system is followed by repressurization of the water providing sufficient pressure to move at the required rate through a degasification membrane filter and through an ultraviolet sanitization chamber. This treatment may be required to treat the supply water from the storage system. Determination of the proper treatment process is made from interpretation of the supply water analysis. Carbon dioxide and other weakly acidic ionic species are not as easily removed form the supply water as are strongly acidic ionic species. Use of ultraviolet sanitation is advantages to reduce the possibility of biological growth in the reverse osmosis chamber in the still areas around the brine seals. Finally the water stream is boosted in pressure sufficient enough to pass water through a reverse osmosis membrane. Again depending on the supply water analysis a second reverse osmosis membrane system might be required to further remove the ionic salts to the acceptable limits for treatment by a Continuous Electronically Regenerated Ion-exchange apparatus. The CEIX. (electrodeionization apparatus) replaces the offsite regenerated ion-exchange columns. The final treatment device is a submicron or ultrafiltration cartridge for the six log removal a pyrogens or viruses.

### BRIEF DESCRIPTION OF THE DRAWINGS

FIG. 1: Submitted Alternate Method to be classified by USFDA under FIP Class II,

FIG. 2: Existing Method as classified by USFDA under FIP Class II,

FIG. 3: In Vitro continuous regeneration, biostatics diagram.

FIG. 4: Demonstration of ionic movement within the CEIX (electrodeionization apparatus).

FIG. 5: Demonstration of Hydrogen proton and hydroxyl ionic movement with in the CEIX (electrodeionization apparatus).

FIG. 6: A demonstration of research reflecting the polarization of the ionic solids and water in a CEIX (electrodeionization apparatus).

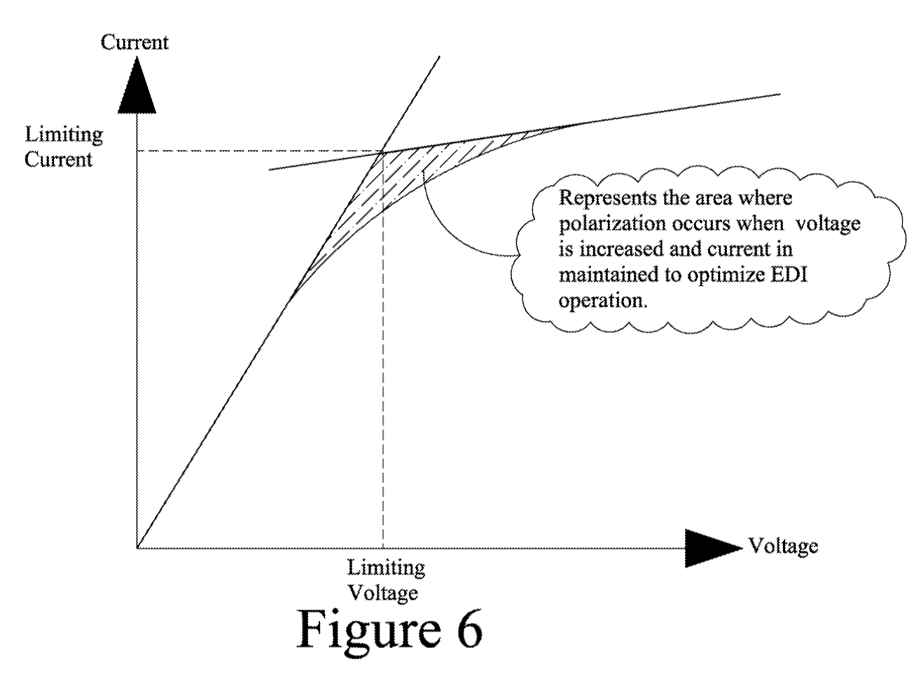

Table 1: This table relates the electrochemical potential of specific ions in a solution of purified water.

The notations on each drawing is used to indicate: a) 10 through 29 indicate pretreatment technology, b) 30 to 49 indicate reverse osmosis equipment, c) 50 through 69 indicate storage equipment, d) 70 through 89 indicate post final treatment systems, and e) 90 through 109 are used to describe the CEIX (electrodeionization apparatus) process.

### DETAILED DESCRIPTION OF THE INVENTION

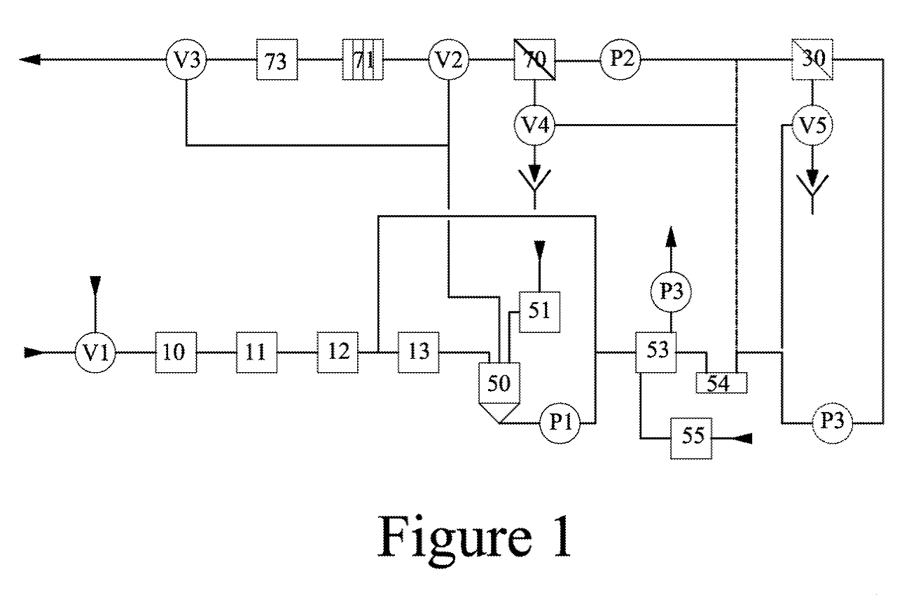

FIG. 1 illustrates the advantages of the disclosed process. The pretreatment, items V1, 10, 11, 12 13, and all variations of such remain the same and are dependent on the quality of the supply water as verified by analysis and onsite inspection.

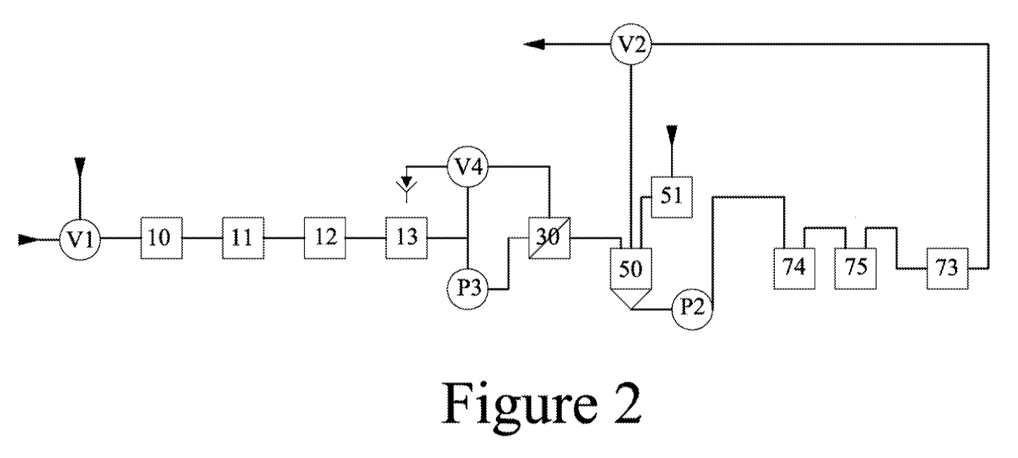

The first departure from previous technology is the placement of the supply storage tank 50 before the membrane separation unit. The advantage is the assurance that if there is a failure in the hydrophobic vent filter system 51 or elsewhere in the sealing of the storage tank, dust, bacteria and virus are removed by the Reverse Osmosis/Continuous electric ion-exchange (RO/CEIX) before entering use. If the customer desires a treated water storage system the current technology as illustrated on FIG. 2 does not meet the requirements of USP water storage which require both heat sanitization as chemical sanitization, therefore, moving the storage is prudent and allows for current storage protocols as does the existing configuration.

FIG. 1 includes equipment needed to treat the worst case situation where the supply water where to treat the supply water to the quality demanded by ASTM Type 1 reagent grade a double pass reverse osmosis unit is needed. The dash dot line depicts the standard system where a double pass RO system is not needed. Typically when the supply water ionized solids is below 1000 mg/1 or 1700 MicroSiemens (uS).

Between the storage pressure boosting pump P1 and the RO/CEIX pressure boosting pump P2 a degasification system is installed, hems 53, 55 and P3 depict a common method of degasification item 53 is a membrane degasification cell that separates carbon dioxide and other gasses from the water. Item 55 is a hydrophobic dust prevention filter. Item P3 is a vacuum pump. Variations on this arrangement exist, but the ultimate goal it to remove carbon dioxide entrained in the supply water to the RO/CEIX thereby reducing to load on the process making it more efficient. Item 54 is an ultraviolet sanitizing system typically employing a 254 nanometer wave length bulb to neuter bacteria passing through the chamber. However, a 180 nanometer bulb system can be used if the analysis or the customer require this level of technology. The 185 nanometer wave length light breaks down the cell walls of living organic organism. Generally accepted NSF/ANSI guidelines are set under their procedure; NSF/ANSI 55-2004 Ultraviolet Microbiological Water Treatment Systems NSF International/1-Oct.-2004/66 pages

Before the reverse osmosis booster pump P2 a return line is located to allow maximum recovery of the process and is typical of the application described. Valve V4 controls the recycle flow; check valves are included to prevent water flow in the wrong direction,

The RO/CEIX process involves pump P2, reverse osmosis plant 70, valve V2, the CEIX apparatus 71, the submicron filter 73 and valve V3. The dash line system adds a pretreatment reverse osmosis unit that will reduce the supply water total dissolved solids (TDS) is reduced by greater than ninety eight and one half (98.5) percent to the RO/CEIX apparatus when the ionized solids is greater than 1700 uS. Valve V2 diverts water to drain when water is called for and continues until the water quality is sufficient to pass thought the CEIX unit 71. Valve V3 is normally open and is closed when the permeate of the CEIX reaches design quality selected by the operator.

Membrane manufacturing and storing technology is improving over the last twenty years as typified by prior invitations U.S. Pat. No. 4,906,372, 5,538,642, and 7,156,997. The days of patching manually with urethane epoxy are passed, today membrane quality at the six sigma level making bacteria grow through because of flaws in the surface of the membranes nearly impossible. Similarly machining technology of the interconnects between membranes and the adapters to the pressure vessel assemblies create tolerances that permit the o-rings to make a positive seal on three hundred sixty degrees on the surfaces of the machined parts greatly discouraging leakage of salts and biological grow by. Rated membrane rejection of the salt sodium chloride, compound consisting of two monovalent ions Na⁺ and Cl⁻, molecular weight of 23 and 35.5, have risen from the DuPont B9 membrane of 90 percent rejection to Koch's Fluid Systems' HR series, or Hydranautics' CPA series of 99.7 percent rejection of sodium chloride. Taylor and Jacobs explain that the DuPont hollow fiber and subsequent spiral wound technologies examples referenced above, are based on amide chemistry but the difference lay in the methods of fabrication; that being membrane configuration and design, polymer casting techniques, as well as improving the mechanics of fabricating the components and assembling the membranes. The improved ionic rejection correlates linearly to the prevention of biological passage through or around the membrane.

The following is taken from OEM Engineering Manual XL Series EDI, SNOWPURE LLC, 2006 VERSION 2.6.5(XL) “The electrodeionization process uses a combination of ion-selective membranes and ion-exchange resins sandwiched between two electrodes (anode (+) and cathode (−)) under a DC voltage potential to remove ions from RO-pretreated water.” The holder of patent U.S. Pat. No. 4,465,573, founding author of the manual, recognized reverse osmosis as a pretreatment as early as 1984; since that time of his invention the afore mentioned improvements plus many proprietary have been made in the design and manufacturing or membrane bundles.

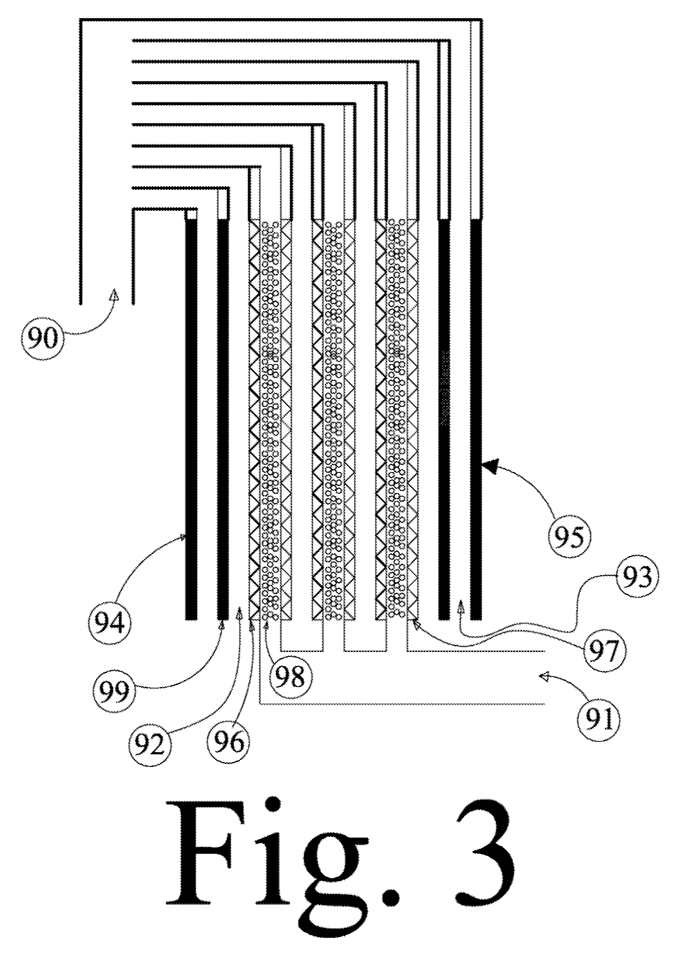

FIG. 3 describes the electrodeionization apparatus. Water enters the stack 90 and is divided into three streams, they are: 91 indicate the treated permeate, 92 indicate the concentrate flush where concentrate is flushed from the resin cells, and 93 indicate the acolyte flush that flush and cool the cathode and the anode. The components of the stack are: 94 indicate the anode, 95 indicate the Cathode, 96 indicate the anion permeable membrane, 97 indicate the cation permeable membrane, 98 indicate the mixed bed ion-exchange resin, and 99 indicate the neutral barrier inert and not permeable membrane separating the Electrolyte channel from the concentrate channel.

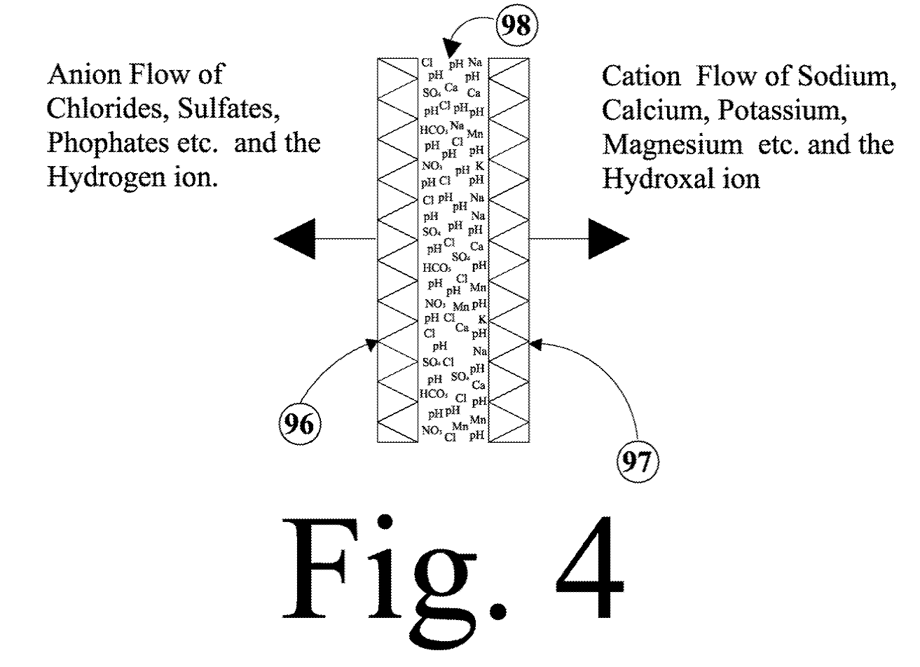

FIG. 4 describes the flow of ions within a single module within the stack. 96 indicate the anion permeable membrane, 97 indicate the cation permeable membrane and 98 represent the resin. The purpose of this is drawing is to depict the ion movement with in the module and provide a visualization of the limited polarization within the module.

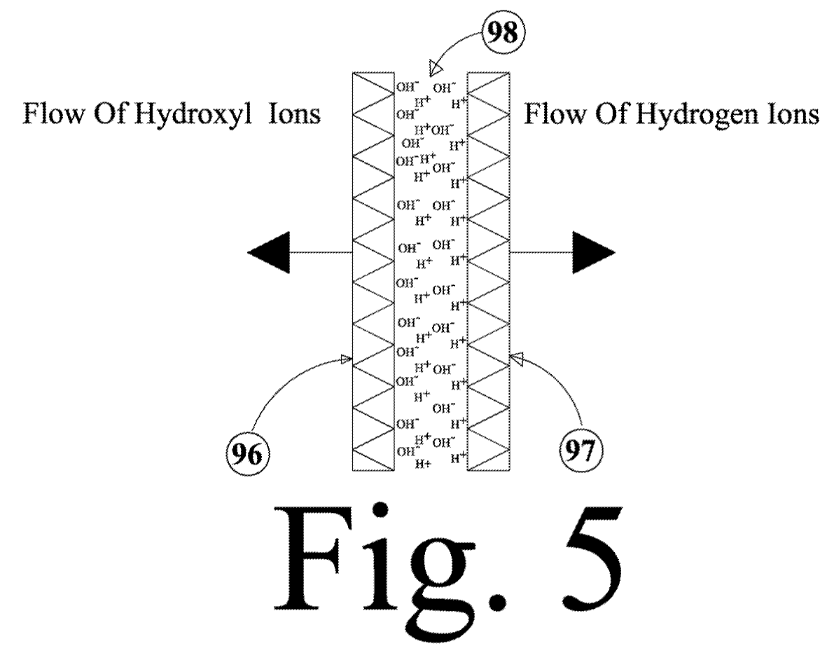

FIG. 5 is a further depiction of the polarized water movement within each module. 96 indicate the anion permeable membrane, 97 indicate the cation permeable membrane and 98 represent the resin. The movement of the ions through the resin bed creates drastic pH swings around the resin beads. The fluid pH swings create a biostatic environment where bacteria cannot colonize; therefore the bed is biostatic at the minimum and indeed may be sterile in the best case.

Example 1 is the demonstration of a balanced system when voltage and current are optimized; polarization is limited however the phenomenon of ionic hydrogen and hydroxide is still existent. The closer to the cathode the greater is the concentration of hydrogen ion, a reason that the Electrolyte must be vented to atmosphere to release the hydrogen gas. The third (electrolyte) stream flows past the anode and cathode sequentially. Snowpure's OEM manual states” The anolyte-bathing stream first flows past the anode (+) through a compartment formed by a gasketed monofilament screen, which is located between the anode and an adjacent anion-selective membrane. In this compartment, the pH drops and C12 (dissolved) and O2 (gas) are generated. This stream then flows into the cathode compartment, formed between the cathode (−) and its adjacent cation-selective membrane. In this compartment H2 (gas) is generated. Thus, the waste stream expels the unwanted chlorine, oxygen, and hydrogen gas from the electrodes. The purpose of this example is to provide a graphic depiction of polarization as described in paragraphs [0028 and 0029]. Polarization is the device of which the ion-exchange resins in the CEIX cell is regenerated and the mechanism creating the biostatic, hence prophylactic state of the cell.

Example 2 involves the discussion of electrochemistry by Stephen Lower, stating that is the study of reactions in which charged particles (ions or electrons) cross the interface between two phases of matter, typically a metallic phase (the electrode) and a conductive solution, or electrolyte. A process of this kind can always be represented as a chemical reaction and is known generally as an electrode process. Electrode processes (also called electrode reactions) take place within the double layer and produce a slight unbalance in the electric charges of the electrode and the solution. Much of the importance of electrochemistry lies in the ways that these potential differences can be related to the thermodynamics and kinetics of electrode reactions. In particular, manipulation of the interfacial potential difference affords an important way of exerting external control on an electrode reaction.

The interfacial potential differences which develop in electrode-solution systems are limited to only a few volts at most. This may not seem like very much until you consider that this potential difference spans a very small distance. In the case of an electrode immersed in a solution, this distance corresponds to the thin layer of water molecules and ions that attach themselves to the electrode surface, normally only a few atomic diameters. Thus a very small voltage can produce a very large potential gradient. For example, a potential difference of one volt across a typical 10-8 cm interfacial boundary amounts to a potential gradient of 100 million volts per centimeter—a very significant value indeed! Table 1 demonstrates the possible voltage relationship of various ions in pure water.

Mr. Lowers' discussion is the heart of the principal of operation of an EDI Apparatus as described in the various patents referenced here and cited by those patents. A residual benefit of the electro chemical activity is the creation of a biostatic environment or a prophylactic system where bacteria do not colonize; therefore, increase in numbers providing an effluent stream of the apparatus biological neutral apposed to the inlet to the cell. Technically living mater is subject to the same electrochemistry as soluble ions, because cell bodies are micro EDI apparatus. Each cell body is an electrochemical microcosm so when placed into a strong electro potential field as created inside an EDI apparatus the individual ions in solution in the sea of protoplasm are subject to the same rules as the ionic substances shown in Table 1. The electrical potential across the biological cell disrupts that cell preventing mitosis and colonization if not destroying the cell.

What is claimed:

1. Benefits have been determined to take advantage of electrodeionization (EDI) an apparatus that combines well-established water purification technologies i.e. electrodialysis and ion-exchange resin deionization as further treatment of Reverse Osmosis permeate to ensure that biologically purified water for medical and, or pharmacological uses is maintained or enhanced. To ensure that the quality of the treated water by the CEIX (electrodeionization apparatus) is as biological sterility as was provided to the apparatus from the preceding treatment devices. CEIX (electrodeionization apparatus) is a process created by the introduction of an electrical potential across an ion-exchange resins enclosed by charged semi-permeable plastic membranes, it is the electrochemical reactions created within the apparatus that drives the purification process that make this device a suitable for long term instillation thereby especial over the existing transient technology.

2. A method and apparatus according to claim 1, the continuous regeneration created by the strong electrical potential across the cell that creates fluxional swings within regions of that cell that are not conducive as a medium for biological activity.

3. A method and apparatus according to claim 1 where static pH zones collapse as regeneration and exhaustion of micro regions of the resin bed takes place under normal operating conditions.

4. A method and apparatus according to claim 1, The random perpendicular typology of regenerated cation and anion and exhausted cation and anion resin due to continuously regenerating mixed resin within the chamber do not allow semi-permanent zones of static pH conditions or even static natural pH zones to occur as with off site regenerated mixed resins that exhaust in a predictable matrix creating pockets where bacteria can reside, even if temporary.

5. A method and apparatus according to claim 1 to provide an uninterrupted biostatic environment.

6. A method and apparatus according to claim 1 to provide a sterile, on site regenerations of the ion-exchange resin bed.

7. A method and apparatus according to claim 1 a sterile apparatus allowing years of service without dismantling of, or the exchange of, service DI columns by connecting and disconnecting piping fittings.

8. A method and apparatus according to claim 1, ensures minimal contact, i.e. removal of ion exchange tanks and off site regeneration, with the active media ensures the sterility of that media and the piping structures previous and subsequent to the portable exchangers.

9. A method and apparatus according to claim 1 elimination of external contact with the foreign ion exchange resin in off site and unregulated regeneration facilities.

10. A method and apparatus according to claim 1 defines barriers to the introduction of bacterial, viral or pathogenic contamination.

11. A method and apparatus according to claim 1, protects the final reverse osmosis permeate from biologic grow-through or bacteria pass through from the pretreatment system to the CEIX (electrodeionization apparatus).

12. A method and apparatus according to claim 1, Since biological structure attachment and subsequent growth is discouraged in the continuous electronic regenerating environment of the CEIX (electrodeionization apparatus), final removal of any escaping biological entities are easily captured in a final absolute screening filter.

13. A method and apparatus according to claim 1, Grow by and defects in reverse osmosis structures may occur, thus permitting living single cell orgasms to pass or grow colonies around o-rings or through the damaged membrane. Once these structures break down bacteria is released into the permeate. The CEIX (electrodeionization apparatus) acts as a barrier against these orgasms entering the medical and, or pharmacological uses.

14. A method and apparatus has been identified to arrange the process to reduce the possibility of allowing biological entities to enter the medical and, or pharmacological uses by eliminating post RO/CEIX (electrodeionization apparatus) permeate storage, treating primary supply water storage and placing sterilization systems after that storage and before the apparatus to allow the apparatus to function as described.
